(19) United States
(12) Patent Application Publication
(10) Pub. No.: US 2010/0218135 A1
(43) Pub. Date: Aug. 26, 2010

(54) CURSOR THUMBNAIL DISPLAYING PAGE LAYOUT

(76) Inventors: Thomas Stanton Brugler, Fuquay-Varina, NC (US); Todd Michael Eischeid, Cary, NC (US); Mark E. Molander, Cary, NC (US); Kerry A. Ortega, Raleigh, NC (US)

Correspondence Address: ZILKA-KOTAB, PC- IBM, P.O. BOX 721120, SAN JOSE, CA, 95172-1120, US

(21) Appl. No.: 12/393,868

(22) Filed: Feb. 26, 2009

(51) Int. Cl. G06F 3/048

(52) U.S. Cl. 715/781

(57) ABSTRACT

A method according to one embodiment includes determining a position of a currently-displayed area relative to a viewable area of at least one page of an electronic document; determining if a criterion is met; if the criterion is met, generating a graphical representation of the currently-displayed area relative to the viewable area of at least one page of the electronic document; and outputting the graphical representation to a display device, the graphical representation being positioned in an immediate vicinity of a cursor associated with a user input device. Additional methods and computer program products are presented.

### BACKGROUND

The present invention relates to the presentation of data on a user interface, and more particularly, this invention relates to revealing hidden information on a user interface.

A fairly common usability error that can be noted with today's user interfaces (UIs) occurs when the user is unaware that additional information is available for viewing, but is not displayed, and as a result the information goes unattended.

More specifically, scroll bars have been widely used in today's UIs to allow the user the ability to access information that cannot fit in the display area. To access the hidden information, the user simply selects the scroll bar's arrow buttons (up/down and right/left) to navigate to the hidden information. Unfortunately, the user often fails to detect the scroll bar, and consequently fails to note the hidden information. There are a number of reasons why scroll bars may go undetected.

First, the scroll bars are traditionally placed on the opposite end of the axis from where the window's main content is displayed. That is, the scroll bars are placed on the right and bottom of the display area, and the main content is top and left aligned.

Second, the viewing area might be sized in such a way that the information displayed gives false impression that content is displayed in its entirety. Therefore, the user has no reason to look for scroll bars (whether it is a conscious or unconscious decision is immaterial).

Third, the scroll bar might be attached to a higher level component (e.g., a page) than the area that is being attended (e.g., a property sheet). Each of these three factors can contribute to the problem of users missing hidden information.

Therefore, it would be beneficial to reduce the likelihood of the user missing hidden information by reducing the effect of each of these three factors.

### SUMMARY

A method according to one embodiment includes determining a position of a currently-displayed area relative to a viewable area of at least one page of an electronic document; determining if a criterion is met; if the criterion is met, generating a graphical representation of the currently-displayed area relative to the viewable area of at least one page of the electronic document; and outputting the graphical representation to a display device, the graphical representation being positioned in an immediate vicinity of a cursor associated with a user input device.

A method according to another embodiment includes determining a position of a currently-displayed area relative to a viewable area of an electronic document having several tabbed pages; determining if a criterion is met; if the criterion is met, generating a graphical representation of the currently-displayed area relative to a viewable area of at least two of the tabbed pages of the electronic document; and outputting the graphical representation to a display device.

A computer program product according to one embodiment includes a computer usable medium having computer usable program code embodied therewith, the computer usable program code comprising: computer usable program code configured to determine a position of a currently-displayed area relative to a viewable area of an electronic document; computer usable program code configured to generate a graphical representation of the currently-displayed area relative to a viewable area of at least one page of the electronic document; and computer usable program code configured to output the graphical representation to a display device, the graphical representation being positioned in an immediate vicinity of a cursor associated with a user input device.

A computer program product according to another embodiment includes a computer usable medium having computer usable program code embodied therewith, the computer usable program code comprising: computer usable program code configured to determine a position of a currently-displayed area relative to a viewable area of an electronic document having several tabbed pages; computer usable program code configured to generate a graphical representation of the currently-displayed area relative to a viewable area of at least two of the tabbed pages of the electronic document; and computer usable program code configured to output the graphical representation to a display device.

Other aspects and embodiments of the present invention will become apparent from the following detailed description, which, when taken in conjunction with the drawings, illustrate by way of example the principles of the invention.

### BRIEF DESCRIPTION OF THE SEVERAL VIEWS OF THE DRAWINGS

FIG. 1 is a flow chart of a method according to one embodiment.

FIG. 2 is a flow chart of a method according to another embodiment.

FIG. 3A is a schematic diagram of an application window which may be used in conjunction with a method of visual indication of location according to one embodiment.

FIG. 3B is a schematic diagram of an application window using a method of visual indication of location according to one embodiment.

FIG. 3C is a schematic diagram of an application window using a method of visual indication of location according to one embodiment.

FIG. 3D is a schematic diagram of an application window using a method of visual indication of location according to one embodiment.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified.

The following description discloses several preferred embodiments of displaying layout information to a user, as well as computer products utilizing the same.

In one general embodiment, a method includes determining a position of a currently-displayed area relative to a viewable area of at least one page of an electronic document; generating a graphical representation of the currently-displayed area relative to the viewable area of at least one page of the electronic document; and outputting the graphical representation to a display device, the graphical representation being positioned in an immediate vicinity of a cursor associated with a user input device.

In another general embodiment, a method includes determining a position of a currently-displayed area relative to a viewable area of an electronic document having several tabbed pages; generating a graphical representation of the currently-displayed area relative to a viewable area of at least two of the tabbed pages of the electronic document; and outputting the graphical representation to a display device.

In another general embodiment, a computer program product includes a computer usable medium having computer usable program code embodied therewith, the computer usable program code comprising: computer usable program code configured to determine a position of a currently-displayed area relative to a viewable area of an electronic document; computer usable program code configured to generate a graphical representation of the currently-displayed area relative to a viewable area of at least one page of the electronic document; and computer usable program code configured to output the graphical representation to a display device, the graphical representation being positioned in an immediate vicinity of a cursor associated with a user input device.

In another general embodiment, a computer program product includes a computer usable medium having computer usable program code embodied therewith, the computer usable program code comprising: computer usable program code configured to determine a position of a currently-displayed area relative to a viewable area of an electronic document having several tabbed pages; computer usable program code configured to generate a graphical representation of the currently-displayed area relative to a viewable area of at least two of the tabbed pages of the electronic document; and computer usable program code configured to output the graphical representation to a display device.

In some embodiments, a thumbnail view may be added to a mouse cursor anytime a content area is larger than a viewing area. The content area may be defined as the area in which all of the information may be displayed without shrinking or minimizing any content. The viewing area may be defined as the viewable area of the content area given several factors, including display size, display aspect, window size, etc. The thumbnail would not just be a static icon, but could show the position of the viewing area relative to the content area. Also, as a user scrolls (e.g., up/down arrow), the thumbnail may likewise update its relative position in respect to the content area. Not only could the thumbnail provide location information, but it may also indicate required fields. The main advantage of using the cursor thumbnail over scroll bars, is that it is very unlikely that the user would fail to notice the cursor thumbnail, since the mouse cursor is central to navigation. For example, the user would most likely visually track the mouse cursor to move to a text field, select a new tab, or select an action button, whereas the scroll bars are static items on the navigable page.

According to some embodiments, the layout thumbnail may be displayed only when the content area is greater than the display area. When the display area is the same size or greater than the content area, then the layout thumbnail may not be shown. Also, a setting may be used to choose whether to show the layout thumbnail or not. As the user scrolls, the thumbnail may dynamically update according to its relative position. Also, the thumbnail may display required fields by using red (or any other highly visible color such as chartreuse, violet, orange, etc.) visual indicators. The visual indicators may also appear in a color that is contrasting with the background color. The user could also view review required fields across tabs on the navigable page.

According to more embodiments, the user may select options for how the thumbnail may persist, how and when it may be displayed, when it is enabled, if it is displayed at all, etc. For some users that might find a persisting thumbnail annoying, the user could set an interval for which the thumbnail is to persist. For example, the thumbnail may display on screen for three seconds (or some other selectable or entered length of time), then phase out. Or other users might find the thumbnail beneficial and select a key sequence to persist the thumbnail. When the layout thumbnail is persisted, the user may use the thumbnail to actually scroll, by moving the display area around the content area or by clicking on the content area to scroll to the position. In the case of multiple layout thumbnails, clicking on one could perform a page switch.

As will be appreciated by one skilled in the art, the present invention may be embodied as a system, method or computer program product. Accordingly, the present invention may take the form of an entirely hardware embodiment, a software embodiment (including firmware, resident software, micro-code, etc.) operating an apparatus or an embodiment combining software and hardware aspects that may all generally be referred to herein as a “circuit,” “module” or “system.” Furthermore, the present invention may take the form of a computer program product stored in any tangible medium of expression having computer-usable program code stored in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, or device. More specific examples (a non-exhaustive list) of the computer-readable medium would include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, or a magnetic storage device.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

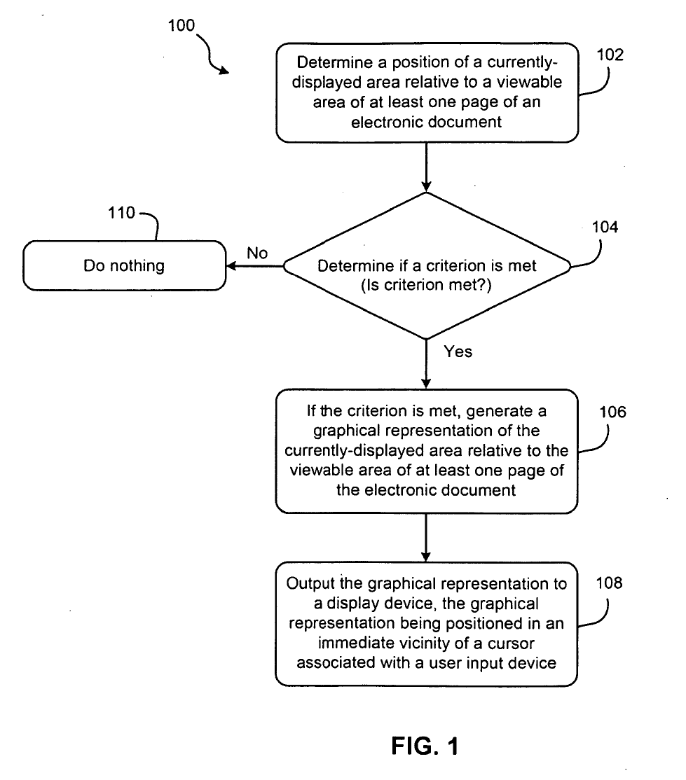

Now referring to FIG. 1, a method 100 is shown according to one embodiment. The method 100 may be used in conjunction with any computer system, server, electronic device, etc., as would be known to one of skill in the relevant art. In addition, the method 100 may be carried out in any desired environment.

In operation 102, a position of a currently-displayed area is determined relative to a viewable area of at least one page of an electronic document. An electronic document may include a web page, a word processing document, an ACROBAT file, a file folder, etc. A page of an electronic document may include a page as delineated by the application in which the electronic document has been created, a page as delineated by the application in which the electronic document has been opened or read, a page as determined by the system reading the electronic document, and/or a page as chosen by the user, etc. Typically, the page may be determined by the application in which the electronic document has been created or is being read or opened.

In operation 104, it is determined if a criterion is met. If the criterion is met, the method 100 proceeds to operation 106. Otherwise, the method 100 proceeds to operation 110, and stops until some event occurs, such as opening of a new page, expansion of the current page, etc., upon which the method may start over.

In some embodiments, the criterion may include a user preference. The user preference may be selected in a menu, through a mouse click, under a preferences tab, etc. The preference selected may be to persist the thumbnail view of the viewable area near the mouse, on a certain portion of the currently-displayed screen, near a corner, etc.

In another embodiment, the criterion may include the viewable area being larger than the currently displayed area. In this embodiment, whenever a user navigates display a screen, and does not display the entire viewable area in the currently-displayed view, the thumbnail may appear to show the relative position of the currently-displayed area versus the viewable area.

In operation 106, a graphical representation of the currently-displayed area is generated relative to the viewable area of at least one page of the electronic document. Some examples of a graphical representation include a representation of the content area, a representation of the viewable area, a small shape (such as a square, rectangle, circle, etc.) representing the viewable area inside of a larger shape (which may be the same shape as the smaller shape, or a different shape) representing the content area, arrows pointing in the direction where the content area is larger than the viewable area (which may be selectable, thus bringing the additional content area into the viewable area), etc. Any graphical representation may be included as a thumbnail, which may be defined as a smaller representation of a larger entity, such as a page, a view, a layout, a viewable area, a content area, etc.

In operation 108, the graphical representation is output to a display device, the graphical representation being positioned in an immediate vicinity of a cursor associated with a user input device. Exemplary input devices include a mouse, a keyboard, a trackball, a touch on a touchpad (such as with a finger or a stylus), a microphone, etc. The immediate vicinity is preferably within less than about 3 inches of the cursor, but may be more or less. 3 inches on a 54 inch plasma screen is certainly within the vicinity of an object on the screen, whereas 3 inches on a 3 inch by 3 inch camera display may not even appear in the viewable image. Therefore, the immediate vicinity is most preferably linked to the actual display size of the screen on which the graphical representation will be displayed.

In some embodiments, the graphical representation may move with the cursor. The location of the graphical representation relative to the cursor may also move depending on the location of the cursor. For example, if the cursor is near the bottom right corner of the screen, then the graphical representation may appear to the upper left of the cursor; however, as the cursor is moved to the upper right corner of the screen, the graphical representation may move toward the lower left of the cursor. In addition, the graphical representation may appear near the cursor in spaces which are not already occupied by other graphical images, such as windows, icons, etc. In addition, the user may select where the graphical representation should appear near the cursor, and/or if the graphical representation should move relative to the cursor.

To enable the movement of the graphical representation, the method 100 may further comprise determining a current position of the cursor and moving the graphical representation to the immediate vicinity of the cursor upon detecting a change in position of the cursor according to some embodiments. In a further embodiment, the graphical representation may not move to the immediate vicinity of the cursor until after the cursor has been substantially motionless for a predetermined period of time, such as 1 second, 2 seconds, etc. In addition, the time period may be set by the user according to some embodiments.

In one approach, the electronic document may include several tabbed pages, wherein the graphical representation may include a subrepresentation for each page of the document. For example, if an electronic document is a word-processing document and includes 4 pages, the graphical representation may include subrepresentations for each page, and may be arranged in the numeric order of the pages of the word-processing document. In a further approach, the subrepresentations may include indicators of predefined content and/or fields. Using the example from above of the word-processing document, each subrepresentations may include the page number of the page it is representing in respect to the word-processing document. In an additional approach, the subrepresentations may include indicators of predefined fields, the fields being required fields for user input. Required fields may appear in a color that is contrasting with the background color, such as blue on white background, red on yellow background, etc. In addition, the user could also view review required fields across tabs on the navigable page. Also, the subrepresentations may show relative sizes of the pages with respect to each other.

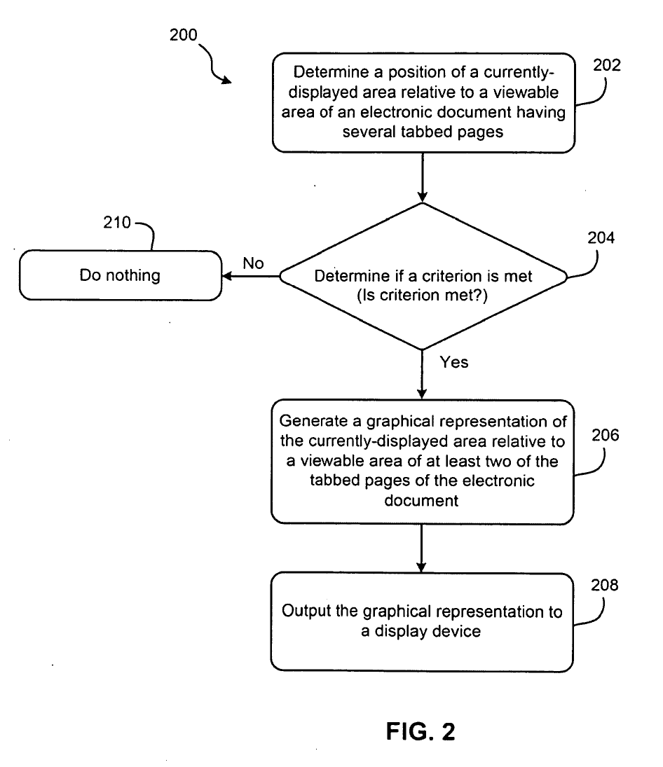

Now referring to FIG. 2, a method 200 is shown according to one embodiment. The method 200 may be used in conjunction with any computer system, server, electronic device, etc., as would be known to one of skill in the relevant art. In addition, the method 200 may be carried out in any desired environment. Also, any of the descriptions from method 100 above may be used to further describe method 200.

In operation 202, a position of a currently-displayed area is determined relative to a viewable area of an electronic document having several tabbed pages. Examples of tabbed pages include individual tabs in internet browsers such as MICROSOFT INTERNET EXPLORER and MOZILLA FIREFOX. Other examples include bookmarked pages in an ADOBE ACROBAT file or on a FACEBOOK webpage, and multiple files opened with the same application in MICROSOFT WINDOWS (which are navigable by cycling between individual windows of the files which are open through a single instance of the application). These examples of tabbed pages are not limiting in any way, and are provided for example only.

In operation 204, it is determined if a criterion is met. If the criterion is met, the method 200 proceeds to operation 206. Otherwise, the method 200 proceeds to operation 210, and stops.

In some embodiments, the criterion may include a user preference. The user preference may be selected in a menu, through a mouse click, under a preferences tab, etc. The preference selected may be to persist the thumbnail view of the viewable area near the mouse, on a certain portion of the currently-displayed screen, near a tab it is representative of, etc.

In another embodiment, the criterion may include the viewable area being larger than the currently displayed area. Since generally only one tab will be viewed at any given time, this criterion may be satisfied whenever a user views a document having more than one tab. In this embodiment, whenever a user navigates display a screen, and does not display the entire viewable area in the currently-displayed view, the thumbnail may appear to show the relative position of the currently-displayed area versus the viewable area. The thumbnails may appear near the tabs which they represent.

In operation 206, a graphical representation is generated of the currently-displayed area relative to a viewable area of at least two of the tabbed pages of the electronic document. For example, if the viewable area spans two pages in an ADOBE ACROBAT file, the graphical representation may include subrepresentations of each of the two pages along with the approximate position of the viewable area on those two pages. Another example includes an application, such as MICROSOFT EXCEL, which has multiple files open. The graphical representation may include all open files, with an indication that the viewable area is currently in one of the opened files.

In operation 208, the graphical representation is output to a display device. A display device may include a computer monitor, an LCD display on a portable electronic device (such as a mobile phone, personal digital assistant, music player, etc.), a television, a projector, etc.

In some embodiments, the graphical representation may be a thumbnail. Also, the graphical representation may be positioned in an immediate vicinity of a cursor associated with a user input device. Further, the graphical representation may move with the cursor.

In some more embodiments, the method 200 may further comprise determining a current position of the cursor and moving the graphical representation to the immediate vicinity of the cursor upon detecting a change in position of the cursor.

In addition, according to some approaches, the graphical representation may include a subrepresentation for each page of the document. Also, in further approaches, the subrepresentations may include indicators of predefined content or fields, and the subrepresentations may include indicators of predefined fields, the fields being required fields for user input. In addition, the subrepresentations may show relative sizes of the pages with respect to each other.

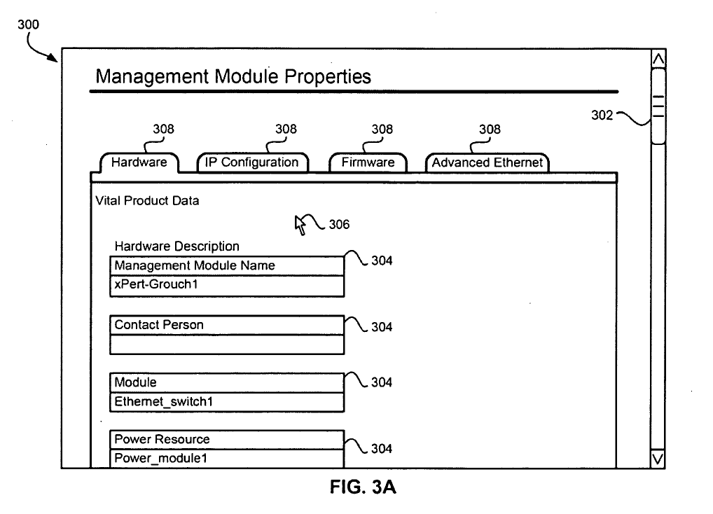

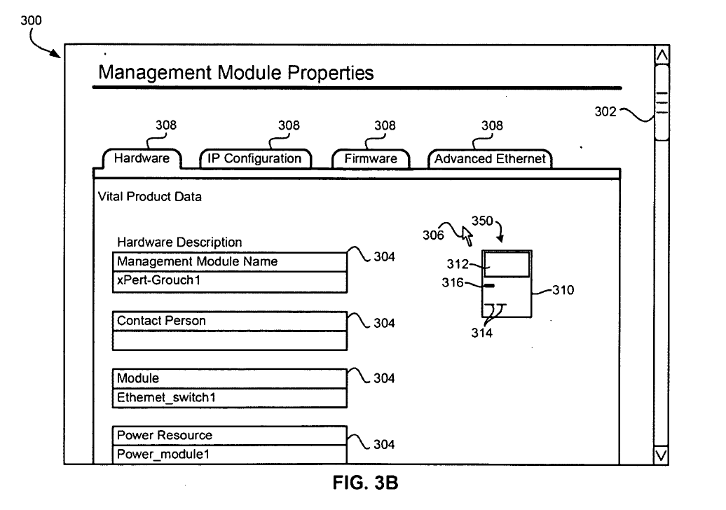

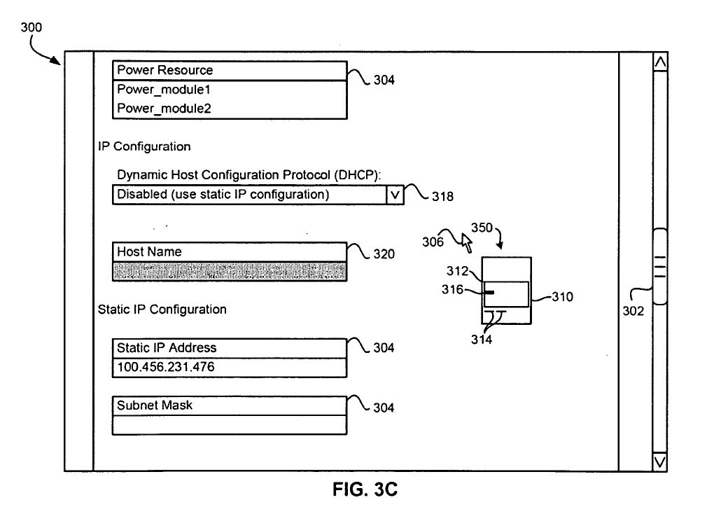

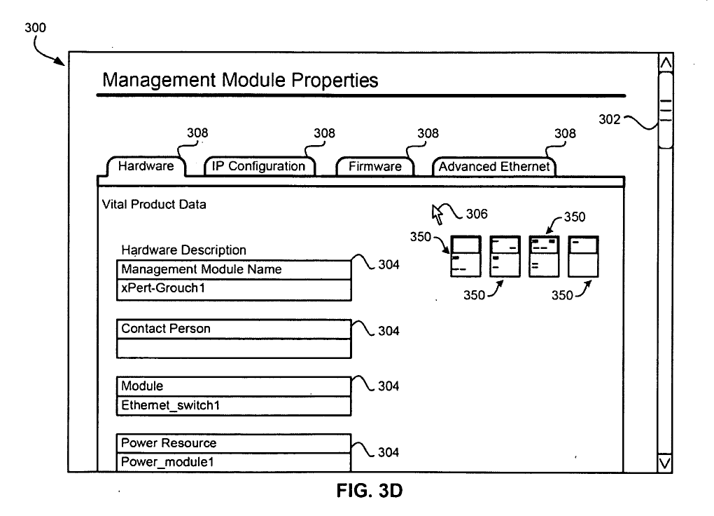

Now referring to FIGS. 3A-3D, some embodiments are described with the help of illustrative windows in an application. Of course, the present invention may be used in any desired environment, and the exemplary windows and tabs are not meant to be limiting in any way.

In FIG. 3A, an application 300 is shown which has a scroll bar 302 on the right side. The scroll bar 302 shows the approximate location of the currently-displayed area in relation to the rest of the viewable area. There are several tabs 308 along the upper portion of the currently-displayed area. Also, the mouse cursor 306 is displayed near the middle of the currently-displayed area. There are also several fields 304 displayed, some of which may already have information displayed (such as the Module Field), and some of which may require some information that has not yet been entered (such as the Contact Person Field).

Now referring to FIG. 3B, a user may have preselected a preference that allows the display of a representation, such as a thumbnail 350, of the currently-displayed area in respect to the viewable area. The thumbnail 350 may include a representation of the currently-displayed area 312 in respect to the viewable area 310. It may also include indications of fields 314 that are incomplete, all fields in general, and/or fields that are required 316. In this instance, the Contact Person Field is not required and there is no information that must be entered into it, so therefore the thumbnail 350 does not have an indication of this field shown. As shown, the thumbnail 350 may appear near the cursor 306, such as near a lower corner portion of the cursor 306. In other embodiments, the thumbnail 350 may appear in a designated area, may move with the movement of the cursor 306, etc.

In FIG. 3C, a view is shown representing a lower portion of the viewable area. As can be seen, the scroll bar 302 indicates that the user has scrolled down in the application 300. The thumbnail 350 now reflects a currently-displayed area representation 312 that is near the middle of the viewable area representation 310. In this view, the Host Name Field 320 is required and thus has a highlighted look. This required field is also indicated on the thumbnail 350 as indication 316. In this fashion, a user can easily and quickly determine where required fields are located in the viewable area 310.

According to some approaches, after a user has entered information into one or more fields and clicked a submit button or otherwise placed the information entered into the fields under scrutiny, the thumbnail may indicate which of the fields have information entered correctly and which have information entered incorrectly or have been flagged as errors (e.g., invalid IP format, invalid characters used (text instead of number, wrong date format, etc.), incomplete field (not enough or too many characters entered for a particular field), etc.). In a preferred embodiment, this may be achieved by highlighting the fields that are flagged as errors in a different color, style, size, etc., than all other fields.

In some embodiments, the indications on the thumbnail 350 may quickly update when a setting, function, and/or field is altered by a user. For instance, if the DHCP Field 318 is changed by a user, it may affect the required Host Name Field 320. The thumbnail 350 may account for these changes, and reflect the nature of the Host Name Field 320 no longer being required by removing the indication 316 from the thumbnail 350.

Now referring to FIG. 3D, an application window 300 is shown according to another embodiment. Here, several thumbnail representations 350 may be shown indicating each of the tabbed pages 308 shown across the upper portion of the screen. In this embodiment, a user may easily review and determine which tabs should be accessed for entering required information, as indicated by the required field indications. These thumbnails may appear near a cursor 306, s shown in FIG. 3D, may appear near each tab across the upper portion of the screen, may appear in a separate pop-up window which may persist above all currently opened windows, etc. Any location and method for displaying the representations (in this case, thumbnails 350) may be used as determined by the user or a program setting/preference.

In some embodiments, the methods described above may be included in a computer program product, the computer program product including a computer usable medium having computer usable program code embodied therewith. The computer usable program code may comprise computer usable program code configured to determine a position of a currently-displayed area relative to a viewable area of an electronic document. The computer usable program code may further comprise computer usable program code configured to generate a graphical representation of the currently-displayed area relative to a viewable area of at least one page of the electronic document, and computer usable program code configured to output the graphical representation to a display device, the graphical representation being positioned in an immediate vicinity of a cursor associated with a user input device.

Another computer program product according to one embodiment may include a computer usable medium having computer usable program code embodied therewith. The computer usable program code may comprise computer usable program code configured for the following: to determine a position of a currently-displayed area relative to a viewable area of an electronic document having several tabbed pages; to generate a graphical representation of the currently-displayed area relative to a viewable area of at least two of the tabbed pages of the electronic document; and to output the graphical representation to a display device.

It will also be clear to one skilled in the art that the methodology of the present invention may suitably be embodied in a logic apparatus comprising logic to perform various steps of the methodology presented herein, and that such logic may comprise hardware components or firmware components.

It will be equally clear to one skilled in the art that the logic arrangement in various approaches may suitably be embodied in a logic apparatus comprising logic to perform various steps of the method, and that such logic may comprise components such as logic gates in, for example, a programmable logic array. Such a logic arrangement may further be embodied in enabling means or components for temporarily or permanently establishing logical structures in such an array using, for example, a virtual hardware descriptor language, which may be stored using fixed or transmittable carrier media.

It will be appreciated that the methodology described above may also suitably be carried out fully or partially in software running on one or more processors (not shown), and that the software may be provided as a computer program element carried on any suitable data carrier (also not shown) such as a magnetic or optical computer disc. The channels for the transmission of data likewise may include storage media of all descriptions as well as signal carrying media, such as wired or wireless signal media.

Embodiments of the present invention may suitably be embodied as a computer program product for use with a computer system. Such an implementation may comprise a series of computer readable instructions either fixed on a tangible medium, such as a computer readable medium, for example, diskette, CD-ROM, ROM, or hard disk, or transmittable to a computer system, via a modem or other interface device, over either a tangible medium, including but not limited to optical or analogue communications lines, or intangibly using wireless techniques, including but not limited to microwave, infrared or other transmission techniques. The series of computer readable instructions embodies all or part of the functionality previously described herein.

Those skilled in the art will appreciate that such computer readable instructions can be written in a number of programming languages for use with many computer architectures or operating systems. Further, such instructions may be stored using any memory technology, present or future, including but not limited to, semiconductor, magnetic, or optical, or transmitted using any communications technology, present or future, including but not limited to optical, infrared, or microwave. It is contemplated that such a computer program product may be distributed as a removable medium with accompanying printed or electronic documentation, for example, shrink-wrapped software, pre-loaded with a computer system, for example, on a system ROM or fixed disk, or distributed from a server or electronic bulletin board over a network, for example, the Internet or World Wide Web.

Communications components such as input/output or I/O devices (including but not limited to keyboards, displays, pointing devices, etc.) can be coupled to the system either directly or through intervening I/O controllers.

Communications components such as buses, interfaces, network adapters, etc. may also be coupled to the system to enable the data processing system, e.g., host, to become coupled to other data processing systems or remote printers or storage devices through intervening private or public networks. Modems, cable modem and Ethernet cards are just a few of the currently available types of network adapters.

It will be further appreciated that embodiments of the present invention may be provided in the form of a service deployed on behalf of a customer to offer service on demand.

It will be clear that the various features of the foregoing methodologies may be combined in any way, creating a plurality of combinations from the descriptions presented above.

Also, while various embodiments have been described above, it should be understood that they have been presented by way of example only, and not limitation. Thus, the breadth and scope of an embodiment of the present invention should not be limited by any of the above-described exemplary embodiments, but should be defined only in accordance with the following claims and their equivalents.

What is claimed is:

1. A method, comprising:
determining a position of a currently-displayed area relative to a viewable area of at least one page of an electronic document;
determining if a criterion is met;
if the criterion is met, generating a graphical representation of the currently-displayed area relative to the viewable area of at least one page of the electronic document; and
outputting the graphical representation to a display device, the graphical representation being positioned in an immediate vicinity of a cursor associated with a user input device.

2. The method of claim 1, wherein the graphical representation is a thumbnail.

3. The method of claim 1, wherein the graphical representation moves with the cursor.

4. The method of claim 1, further comprising determining a current position of the cursor and moving the graphical representation to the immediate vicinity of the cursor upon detecting a change in position of the cursor.

5. The method of claim 1, wherein the electronic document includes several tabbed pages, wherein the graphical representation includes a subrepresentation for each page of the document.

6. The method of claim 5, wherein the subrepresentations include indicators of predefined content or fields.

7. The method of claim 6, wherein the subrepresentations include indicators of predefined fields, the fields being required fields for user input.

8. The method of claim 5, wherein the subrepresentations show relative sizes of the pages with respect to each other.

9. The method of claim 1, wherein the criterion is at least one of a user preference and the viewable area being larger than the currently-displayed area.

10. A method, comprising:
determining a position of a currently-displayed area relative to a viewable area of an electronic document having several tabbed pages;
determining if a criterion is met;
if the criterion is met, generating a graphical representation of the currently-displayed area relative to a viewable area of at least two of the tabbed pages of the electronic document; and
outputting the graphical representation to a display device.

11. The method of claim 9, wherein the graphical representation is a thumbnail.

12. The method of claim 9, wherein the graphical representation is positioned in an immediate vicinity of a cursor associated with a user input device.

13. The method of claim 11, wherein the graphical representation moves with the cursor.

14. The method of claim 9, further comprising determining a current position of the cursor and moving the graphical representation to the immediate vicinity of the cursor upon detecting a change in position of the cursor.

15. The method of claim 9, wherein the graphical representation includes a subrepresentation for each page of the document.

16. The method of claim 14, wherein the subrepresentations include indicators of predefined content or fields.

17. The method of claim 15, wherein the subrepresentations include indicators of predefined fields, the fields being required fields for user input.

18. The method of claim 14, wherein the subrepresentations show relative sizes of the pages with respect to each other.

19. A computer program product, the computer program product comprising:
a computer usable medium having computer usable program code embodied therewith, the computer usable program code comprising:
computer usable program code configured to determine a position of a currently-displayed area relative to a viewable area of an electronic document;
computer usable program code configured to generate a graphical representation of the currently-displayed area relative to a viewable area of at least one page of the electronic document; and
computer usable program code configured to output the graphical representation to a display device, the graphical representation being positioned in an immediate vicinity of a cursor associated with a user input device.

20. A computer program product, the computer program product comprising:
a computer usable medium having computer usable program code embodied therewith, the computer usable program code comprising:
computer usable program code configured to determine a position of a currently-displayed area relative to a viewable area of an electronic document having several tabbed pages;
computer usable program code configured to generate a graphical representation of the currently-displayed area relative to a viewable area of at least two of the tabbed pages of the electronic document; and
computer usable program code configured to output the graphical representation to a display device.
